(19) United States
(12) Patent Application Publication
(10) Pub. No.: US 2013/0098332 A1
(43) Pub. Date: Apr. 25, 2013

(54) Multi-cylinder multi-fuel engine

(71) Applicant: Quincy Clyde Summers, Newburgh, IN (US)

(72) Inventor: Quincy Clyde Summers, Newburgh, IN (US)

(21) Appl. No.: 13/317,542

(22) Filed: Oct. 21, 2011

(51) Int. Cl. F02M 43/00

(52) U.S. Cl. 123/304

(57) ABSTRACT

This engine utilizes the power of cylinder(s) that use diesel fuel which provides great power at slow crankshaft rounds per minute speed. It also utilizes cylinder(s) that operate on dedicated alternant hydrocarbon fuel(s). The fuels do not mix. The diesel cylinder(s) burn only diesel fuel. The alternant hydrocarbon cylinder(s) burn only their assigned fuel. An example would be an engine that had one diesel cylinder and one cylinder that burned natural gas while using a single crankshaft.

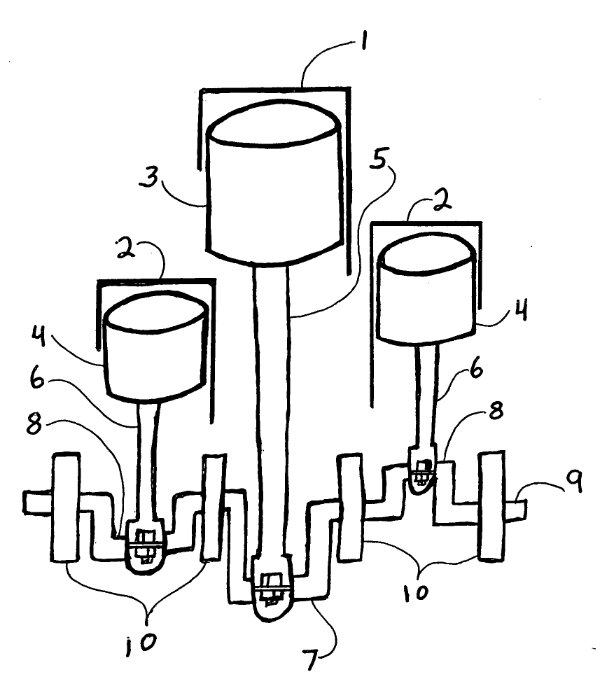

### BACKGROUND OF THE INVENTION

Engines over the years have improved greatly in reliability efficiency and have become increasingly environmentally friendly. Inventors are constantly attempting to expand the flexibility and increase the adaptability of present day engines. This invention takes a different approach. This invention advances the power, fuel efficiency and environmentally friendliness of engines. Within the last twenty years or more there has been a large increase in the utilization of diesel fuel. Because each barrel of oil refined can only produce a certain percentage of diesel fuel, the fuel has transformed from an inexpensive heavy truck enginefuel to a fuel utilized in many power plants and vehicles. This has greatly increased the consumption of diesel fuel. As a result diesel fuel in many locations is now more expensive than other hydrocarbon fuels such as gasoline, natural gas, propane, butane and other fuels. This invention will enable engines to utilize the power of diesel fuel and other fuels while sacrificing minimal power reduction from the diesel fuel used and substantial cost savings by also utilizing an alternant fuel, other than diesel.

### Small Entity Status

Client claims Small entity Status.

### DESCRIPTION OF DRAWING

Referring now to the drawing where partial engine components are shown. The invention is described in conjunction with a three cylinder engine, only as a typical environment in which the invention is to be employed. The invention has practical utility, as will become apparent, in conjunction with engines having multiple combustion chambers, such as reciprocating engines as shown in this embodiment. Where any specific component is not illustrated or described, reference may be had to any conventional construction utilized in the art for the details of reciprocating hydrocarbon internal combustion engines.

In the illustrated embodiment, the engine is a three cylinder reciprocating hydrocarbon internal combustion engine. The three pistons 3 and 4 reciprocate in their respective cylinder bores 1 and 2. The pistons 3 and 4 are connected by connector rods 5 and 6 to the crankshaft 9. Bearings 10 are also shown at locations where the crankshaft 9 would be center-lined through the cylinder block (not shown). The throws 7 and 8 on the crankshaft 9 are shown where the connector rods 5 and 6 attach to the crankshaft 9.

Components 1, 3, and 5 comprise the diesel fueled cylinder and longer stroke mechanism that has a longer throw 7 on the crankshaft 9. Components 2, 4, and 6 comprise the non-diesel fueled cylinders and shorter stroke mechanism that has shorter throws 8 on the crankshaft 9.

### Use of this Invention

This innovative engine can be used where ever diesel engines are used. The most probable utility will be derived from using this invention in tractors that pull trailers, commonly known as “Semi's” or “Eighteen wheelers”. The operational cost per mile traveled is thought to be the greatest benefit of this invention; along with reduced negative engine emission.

### SUMMARY OF THE INVENTION

This engine invention utilizes fairly standard components that are found in today's engines. The exception is that this engine requires a special crankshaft that has long throws for the diesel cylinder(s) and standard length throws for the alternant (natural gas for example) fuel cylinder(s). It may also require a single head or multiple heads for the different fuel cylinder(s) used. It definitely would have to have separate fuel delivery systems for the fuels used. The fuels are dedicated to dedicated cylinders. The fuels are not mixed or blended. By utilizing the diesel cylinder(s) with the alternate fuel cylinder(s) on the same crank shaft, greater fuel power, efficiency and economy is created. The environmentally unfriendly emissions from the exhaust compared to the energy created will be greatly reduced. This is accomplished because the non-diesel cylinder(s) support the diesel cylinder(s) when operating.

### Specifications

This invention is a power plant (engine) that has a single crankshaft with one or more cylinders that utilizes diesel fuel and one or more cylinders that utilize alternant hydrocarbon fuel(s). The power plant would require at least two separate fuel delivery systems.

What is claimed is:

1. Engine utilizes diesel fuel cylinder(s) and alternant hydrocarbon fuel cylinder(s) synchronized to complement each other.

2. Engine utilizes separate fuel delivery systems dedicated to specific cylinders that are designed for that specific fuel.

3. A single crankshaft is utilized with different lengths of throws to accommodate the diesel cylinders and non-diesel cylinders.

4. The stroke length of the pistons varies depending on the specific dedicated fuel used for each cylinder.

5. Cylinders are timed to fire to assist each other in order to achieve efficient compression ratios.

6. Using the different fuels will provide greater power efficiency than if used individually as in a conventional engine.

7. Due to the greater efficiency of the burned fuels, the engine exhaust emissions will contain less environmental contaminates per horsepower produced when compared to conventional engines.

8. Engine contains piston connector rods of different lengths.

9. Engine contains pistons with different size top surface areas.

10. Engine pistons travel different distances within their cylinders.

11. Engine has cylinders that utilize more than one designed compression ratio.
